(19) United States
(12) Patent Application Publication
(10) Pub. No.: US 2005/0133648 A1
(43) Pub. Date: Jun. 23, 2005

(54) Sheet cutting apparatus

(75) Inventor: Haruhiko Horiuchi, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/012,719

(22) Filed: Dec. 16, 2004

(30) Foreign Application Priority Data
Dec. 19, 2003 (JP) 2003-422277

(51) Int. Cl. B02C 18/16

(52) U.S. Cl. 241/236

(57) ABSTRACT

A sheet cutting apparatus is provided with a conveying device which conveys sheets along a conveying path, a counting device which counts the sheets conveyed by the conveying device, a cutting device which receives and cuts the sheets counted by the counting device and carried out of the conveying path, and a bending device which bends a portion of the conveying path located downstream of the counting device at a predetermined angle, and is located to lie between the counting device and the cutting device.

### CROSS-REFERENCE TO RELATED APPLICATIONS

This application is based upon and claims the benefit of priority from prior Japanese Patent Application No. 2003-422277, filed Dec. 19, 2003, the entire contents of which are incorporated herein by reference.

### BACKGROUND OF THE INVENTION

1. Field of the Invention

This invention relates to a sheet cutting apparatus that cuts sheets, such as bank notes.

2. Description of the Related Art

Sheets such as bank notes are sorted as spoiled notes and cut by a sheet cutting apparatus, if they have become old through long-term circulation or if they have cuts, ruptures, scribbles, or tapes sticking thereto.

Sheet cutting apparatuses are classified into those that are included in sheet handling apparatus and used on-line, and those that are independently used off-line. The sheet cutting apparatuses according to the present inventions are used on-line.

If a sheet cutting apparatus is used on-line, a sheet handling apparatus determines whether the sheets are true or false, and proper or spoiled, as disclosed in Jpn. Pat. Appln. KOKAI Pub. No. 2002-192002. The sheets determined as spoiled notes are carried at a predetermined speed and counted by a counting sensor. Then, they are fed to a sheet cutting apparatus and cut thereby. Air is blown downward on the cutting pieces from an air nozzle, and thereby the cutting pieces are sent into a discharge port, and discharged and stored in a storage box.

The sheets determined as proper are sorted and accumulated in accumulating sections, and are sealed by a paper wrapper each time the accumulating number of sheets reaches 100.

However, in prior art, a counting sensor that counts the number of sheets is arranged in the vicinity of a cutting blade. Therefore, when the cutting pieces cut by the cutting section rise into the air, they obstruct the counting sensor and cause the problem that the number of cut sheets cannot be accurately counted.

It is possible to prevent cutting pieces from obstructing the counting sensor by arranging the counting sensor distant from the cutting blade. However, if sheets remain in the apparatus due to trouble in the sheet cutting apparatus, there is the fear that it is impossible to judge whether the remaining sheets are counted or not counted. Therefore, the counting sensor is disposed as close as possible to the cutting blade.

Further, in the prior art, since air is only blown from the air nozzle, the pressure in a portion above the air nozzle in the cutting section decreases. Due to the decrease, the cutting pieces rise and adhere to the cutting blade, and thereby the cutting performance decreases.

### BRIEF SUMMARY OF THE INVENTION

The present invention has been made in consideration of the above circumstances. The object of the present invention is to provide a sheet cutting apparatus which prevents cutting pieces from obstructing a sensor counting the number of sheets and enables accurate counting of the number of cut sheets.

A sheet cutting apparatus according to an aspect of the present invention comprises: a conveying device which conveys sheets along a conveying path; a counting device which counts the sheets conveyed by the conveying device; a cutting device which receives and cuts the sheets counted by the counting device and carried out of the conveying path; and a bending device which bends a portion of the conveying path located downstream of the counting device at a predetermined angle, and is located to lie between the counting device and the cutting device.

A sheet cutting apparatus according to another aspect of the present invention comprises: a conveying device which conveys sheets along a conveying path; a counting device which counts the sheets conveyed by the conveying device; a cutting device which receives the sheets counted by the counting device and carried out of the conveying path into a casing, cuts the sheets by a cutting section, and discharges cutting pieces being the cut sheets from a discharge port; and an air nozzle which blows air onto the cutting section and sends the cutting pieces to the discharge port.

A sheet cutting apparatus according to another aspect of the present invention comprises: a conveying device which conveys sheets along a conveying path; a counting device which counts the sheets conveyed by the conveying device; a cutting device which receives the sheets counted by the counting device and carried out of the conveying path into a casing, cuts the sheets by a cutting section, and discharges cutting pieces being the cut sheets from a discharge port; an air nozzle which blows air onto the cutting section and sends the cutting pieces to the discharge port; and an intake port section which is provided on a side of the casing opposite to the discharge port, and takes the air into the casing with blow of air by the air nozzle.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the preferred embodiments given below, serve to explain the principles of the invention.

FIG. 1 is a schematic structural diagram illustrating a sheet handling apparatus equipped with a sheet cutting apparatus according to an embodiment of the present invention.

FIG. 2 is a front view illustrating a main part of the sheet cutting apparatus.

FIG. 3 is a side view illustrating guide plates and feed rollers of the sheet cutting apparatus.

FIG. 4 is a front view illustrating the guide plates and the feed rollers of the sheet cutting apparatus.

FIG. 5 is a cross-sectional view taken along line V-V in FIG. 4.

### DETAILED DESCRIPTION OF THE INVENTION

An embodiment of the present invention will now be described with reference to drawings.

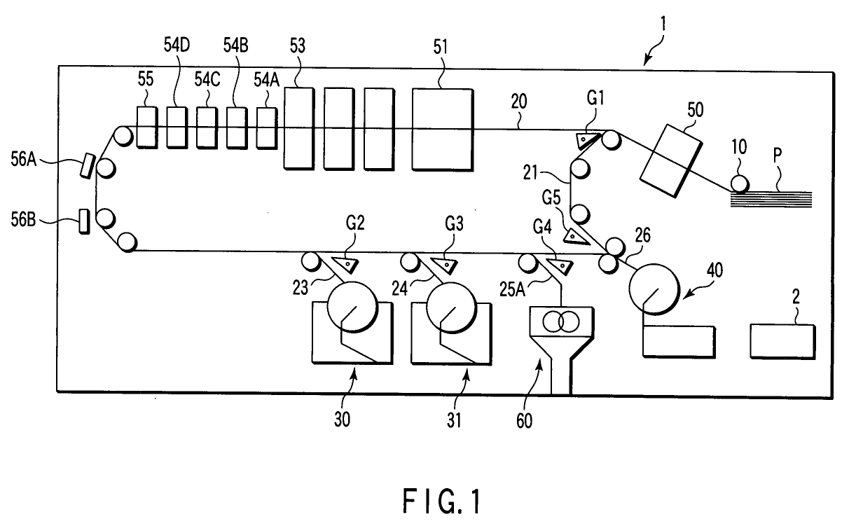

FIG. 1 is a structural diagram illustrating a sheet handling apparatus 1 according to an embodiment of the present invention.

The sheet handling apparatus 1 determines whether sheets P such as bank notes are true or false (true notes or false notes), and proper or spoiled (recirculatable proper notes or spoiled notes which cannot be recirculated). The sheets P determined as proper notes are sorted and accumulated in an accumulating section, and sealed by a paper wrapper for every 100 sheets. The sheets P determined as spoiled notes are cut by a sheet cutting apparatus, and stored in a storage box.

The sheet handling apparatus 1 has a feeding section 10 that takes out the sheets P supplied in a batch one by one and feeds them at predetermined intervals. The sheets fed from the feeding section 10 are conveyed along a conveying path 20. On the conveying path 20, processing sections 50-56B are arranged in the conveying direction of sheets. The processing sections 50-56B determine the property of the sheets P. In the downstream portion in the sheet conveying direction of the conveying path 20, arranged are accumulating sections 30 and 31 in which sheets P determined as proper notes by the processing sections 50-56B are accumulated, a sheet cutting apparatus 60 which cuts the sheets P determined as spoiled note, and a rejection note accumulating section 40 in which false notes or rejectable notes are accumulated.

The processing section 50 detects a conveyance state of the sheets P fed from the feeding section 10, and notifies the control section 2 of the detection result. If the detection result of the conveyance state is, for example, double notes, conveying position displacement and skew, it is impossible to convey the sheet downstream in the conveying direction. Therefore, the processing section 50 notifies the control section 2 of abnormal conveyance.

When the control section 2 receives the notification of abnormal conveyance, the control section 2 rotates a distribution gate G1, which distributes sheets P among the conveyance directions, in the left direction in FIG. 1, and rotates a distribution gate G5 in the right direction in FIG. 1. Thereby, the sheet P is conveyed along a conveying path 21 and then accumulated in the rejection note accumulating section 40.

The processing section 51 has a function of determining the type of note of sheets P or determining whether each sheet P is proper or spoiled. In determining type of note, if the sheets P are Japanese yen notes, the processing section 51 determines the type of note, including 1,000 yen note, 2,000 yen note, 5,000 yen note and 10,000 yen note, and the conveyance state (normal/inverted, front/back) of each sheet P. Further, in determining whether each sheet is proper or spoiled, the processing section 51 determines whether each sheet P is a proper note or a spoiled note.

The processing section 53 has a function of sensing the shape of each sheet P. The processing section 53 senses the length, the width, holes and rupture of each of the sheets P, and notifies the control section 2 of the sense result. If the length or width of the sheet P exceeds the set value of the set note type, the sheet is determined as rejection note.

Each of the processing sections 54A and 54B has a function of sensing magnetism of each sheet P. The processing sections 54A and 54B sense the magnetic amount of each sheet P, and notify the control section 2 of the sensing result. If the magnetic amount of the sheet P exceeds the set value or a predetermined magnetic amount does not exist in a predetermined position of the sheet, the sheet P is determined as rejection note.

Each of the processing sections 54C and 54D has a function of sensing fluorescence amount of sheets P. The processing sections 54C and 54D sense the fluorescence amount of each sheet P, and notify the control section 2 of the sensing result. If the fluorescence amount exceeds the set value or a predetermined fluorescence amount does not exist in a predetermined position of the sheet, the sheet is determined as rejection note.

The processing section 55 has a function of sensing the thickness of sheets P. The processing section 55 senses the thickness of each sheet P, and notifies the control section 2 of the sensing result. If the thickness of the sheet P exceeds the set value, the sheet P is determined as rejection note.

Each of the processing sections 56A and 56B has a function of sensing tape adhered, and senses tape adhered to sheets P. If the size of the adhered tape does not exceed the set value, the sheet P is determined as spoiled note. If the size of the adhered tape exceeds the set value, the sheet P is determined as rejection note.

As the results of processing by the processing sections 50-56B, the proper notes are supplied to the accumulating sections 30 and 31, the spoiled notes are supplied to the sheet cutting apparatus 60, and the rejection notes are supplied to the rejection note accumulating section 40. In the accumulating section 30, the first 100 notes of the sheets P determined as proper notes as a result of processing by the processing sections 50 to 56B are accumulated. In this operation, a distributing gate G2 is rotated in the right direction in FIG. 1, and the sheets P are conveyed into a conveying path 23 and accumulated in the accumulating section 30. With passage of 100 sheets, the distributing gate G2 is rotated in the left direction to prevent sheets from being continuously accumulated on the accumulated 100 sheets. Simultaneously, a distributing gate G3 is rotated in the right direction in FIG. 1 and conveys the 101st proper sheet P and following conveyed sheets to the accumulating section 31.

The sheets P constituted by the 100 proper notes accumulated in the accumulating section 30 are sealed by a paper wrapper (not shown). In the same manner, when the proper notes accumulated in the accumulating section 31 reaches 100, the distributing gate G3 is rotated in the left direction in FIG. 1. This prevents continuous accumulation of sheets on the accumulated 100 sheets. Further, simultaneously, the distributing gate G2 is rotated in the right direction in FIG. 1, and next 100 sheets are accumulated in the accumulating section 30.

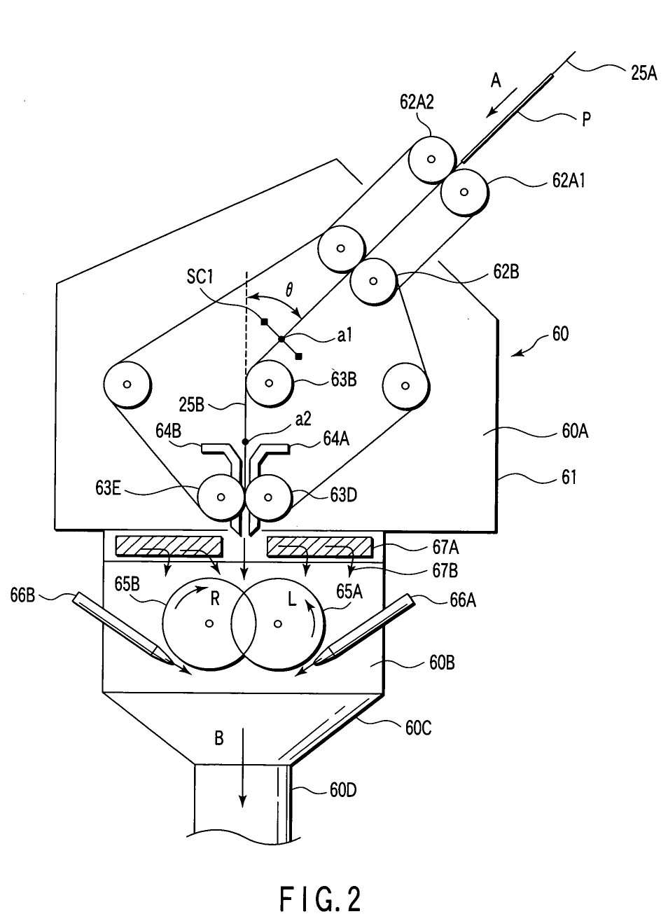

Next, the structure of the sheet cutting apparatus 60 is explained with reference to FIG. 2.

The sheet cutting apparatus 60 comprises a sheet counting section 60A that counts sheets P to be cut, and a sheet cutting section 60B serving as cutting device that cuts the sheets P.

The sheet counting section 60A has a function of counting the sheets P determined as spoiled notes by the processing sections 50-56B of the sheet handling apparatus 1. The sheet counting section 60A has a pair of taking rollers 62A1 and 62A2 that take in sheets P determined as spoiled notes by one of the processing sections in the sheet processing apparatus 1 and conveyed in the direction of an arrow A shown in FIG. 2 along a conveying path 25A (conveying device), and a sensor SC1 (counting device) that senses and counts the taken sheets P.

Further, the sheet counting section 60A comprises a bending roller 63B (bending device) that bends the conveying path 25A for the sheets P by a predetermined angle θ, a pair of guide plates 64A and 64B that guide the sheets P on the conveying path 25B (conveying device) bent by the bending roller 63B into the sheet cutting section 60B, a pair of feed rollers 63D and 63E that feed the sheets P to the sheet cutting section 60B, and a main body cover 61.

The sheet cutting section 60B has cutting blades 65A (first cutting blade) and 65B (second cutting blade) that cut the sheets P fed by the feed rollers 63D and 63E of the sheet counting section 60A, air nozzles 66A and 66B that blow air on the cutting blades 65A and 65B to send cutting pieces downward, air intake ports 67A that take the outside air into the sheet cutting section 60B, a cutting section cover 60C serving as casing that guides the cutting pieces in the direction of an arrow B in FIG. 2, and a cutting piece discharge port 60D for discharging the cutting pieces.

Next, a sheet cutting operation of the sheet cutting apparatus 60 is explained.

Sheets P are supplied to the sheet cutting apparatus 60 one by one at predetermined intervals at a fixed speed set based on the processing speed of the sheet handling apparatus 1. The sheets P to be supplied are sheets determined as spoiled notes by the processing sections 50-56B, they are continuously supplied at predetermined intervals or intermittently supplied, according to the rate of spoiled notes.

Each of the supplied sheets P is held between the taking rollers 62A1 and 62A2 and taken into the sheet counting section 60A. The taken sheets P are counted by passing through the sensor SC1. Each of the sheets P that has passed through the sensor SC1 is supplied to the guide plates 64A and 64B after their conveying direction is bent by the angle θ by the bending roller 63B. Each of the sheets P supplied to the guide plates 64A and 64B is held between the feed rollers 63D and 63E, discharged from the sheet counting section 60A into the sheet cutting section 60B, and cut therein.

The function of the bending roller 63B is explained below.

The bending roller 63B is disposed between a sensing position al of the sensor SC1 on the conveying path and a position a2 of the guide plates 64A and 64B on the conveying path close to the cutting blades 65A and 65B. Even if cutting pieces are blown up in the sheet cutting section 60B, this structure prevents the cutting pieces from obstructing the sensor SC1 and prevents occurrence of a counting error.

Specifically, the bending roller 63B is provided to be located on a straight line connecting the sensing position al being the center position of the sensor SC1 on the conveying path and the central position a2 of the guide plates 64A and 64B on the conveying path. Therefore, cutting pieces blown up from the sheet cutting section 60B are blocked by the bending roller 63B. As a result, the cutting pieces do not obstruct the light of the sensor SC1, and thereby a counting error is prevented.

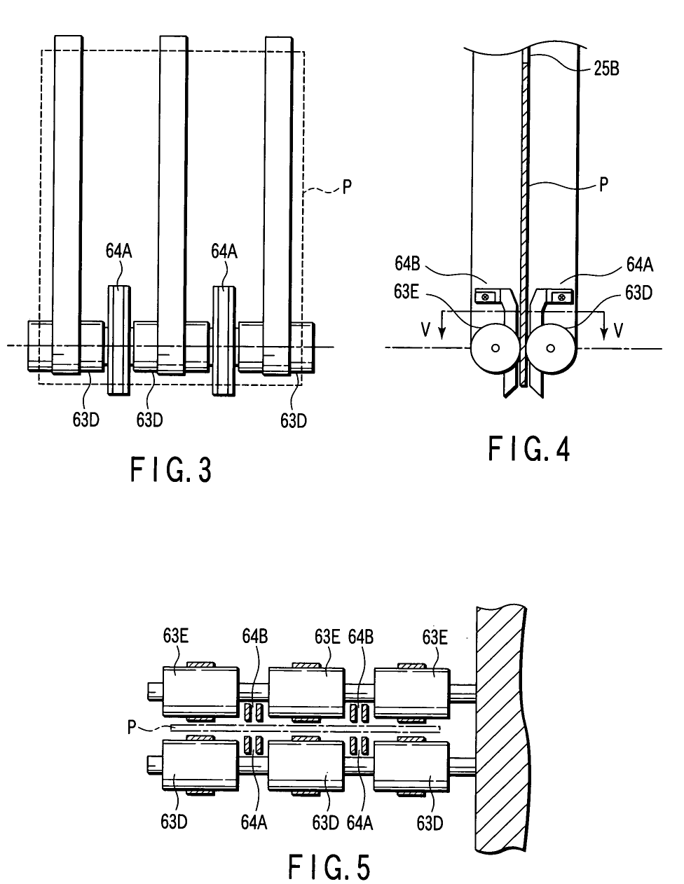

Next, the function of the guide plates 64A and 64B is explained with reference to FIGS. 3-5.

FIG. 3 is a side view of the feed rollers and the guide plates of the sheet cutting apparatus, FIG. 4 is a front view thereof, and FIG. 5 is a cross-sectional view taken along a line V-V in FIG. 4.

The sheets P are conveyed in the state of being held between the feed rollers 63D and 63E on the conveying path 25B of the sheet counting section 60A. Therefore, for example, if the guide plates 64A and 64B do not exist, when a distal end of the sheet P is discharged from the feed rollers 63D and 63E, there are cases where the sheet P sticks to the feed rollers 63D and 63E and paper jam occurs.

Therefore, the guide plates 64A and 64B are provided such that their distal ends in the sheet conveying direction project downward from contacting surfaces of the feed rollers 63D and 63E. Thereby, it is possible to separate the sheet P from the feed rollers 63D and 63E, and convey the sheet P to proceed straight ahead to the sheet cutting section 60B.

The following is explanation of the sheet cutting section 60B.

Each of the sheets P is sent out from the feed rollers 63D and 63E, discharged from the guide plates 64A and 64B, and taken into the sheet cutting section 60B.

In the sheet cutting section 60B, the cutting blades 65A (first cutting blade) and 65B (second cutting blade) described above are arranged. Each of the cutting blades 65A and 65B has a structure in which a plurality of disc-shaped blades each having projecting edges on its periphery are arranged at regular intervals on the central shaft thereof. Side surfaces of the disc-shaped blades forming the cutting blade 65A (first cutting blade) are engaged with the side surfaces of the disc-shaped blades forming the cutting edge 65B (second cutting edge) to contact each other, and thereby form a shredder that cuts the sheets P.

The cutting blade 65A is rotated in the direction shown by an arrow L in FIG. 2, and the cutting blade 65B is rotated in the direction shown by an arrow R in FIG. 2. The sheets P are conveyed into a position where the cutting blade A is engaged with the cutting blade B, and cut therein.

Further, air nozzles 66A and 66B are arranged in the vicinity of the cutting blades 65A and 65B, respectively. The air nozzles 66A and 66B blow air onto the cutting blades 65A and 65b.

As described above, the cutting pieces (about 1.5 mm×10 mm) that have been cut and the cutting pieces adhered to the cutting blades 65A and 65B are collected on the discharge port 60D side in the bottom portion by the air blown from the air nozzles 66A and 66B. In this operation, to ensure downward flow of the air blown from the air nozzles 66A and 66B, the air intake ports 67A are provided in the upper portion of the cover 60C of the sheet cutting section 60B. The air intake ports 67A smooth the flow of air from the air nozzles 66A and 66B. Specifically, without the air intake ports 67A, the pressure in the portion above the air nozzles 66A and 66B in the cutting section decreases due to the air blown to the cutting piece discharge port 60D. Since the cutting pieces tend to collect in the portion of the reduced pressure, the cutting pieces rise in the cutting section.

The air intake ports 67A have a dustproof filter structure or a mesh structure to take in the air. This structure prevents decrease in the pressure, and rise of the cutting pieces.

As described above, according to the embodiment, the conveying path 25B is made by bending the portion of the conveying path 25A located downstream of the counting sensor SC1 by the predetermined angle θ by the bending roller 63B. Thereby, the bending roller 63B blocks the cutting pieces blown up from the sheet cutting section 60B. This prevents the cutting pieces from obstructing the sensor SC1, and enables accurate counting of the number of the cut sheets.

Further, the air blown onto the cutting blades 65A and 65B prevents the cutting pieces from sticking to the cutting blades 65A and 65B, and thereby maintains good cutting performance of the cutting blades.

Furthermore, since the air intake ports 67A are provided on the upper side of the cover 60C of the sheet cutting section 60B, it is possible to take the outside air in through the air intake ports 67A with blow of the air from the air nozzles 66A and 66B. Therefore, it is possible to prevent decrease in the pressure in the portion above the air nozzles 66A and 66B in the cutting section, and securely prevent rise of the cutting pieces.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A sheet cutting apparatus comprising:
a conveying device which conveys sheets along a conveying path;
a counting device which counts the sheets conveyed by the conveying device;
a cutting device which receives and cuts the sheets counted by the counting device and carried out of the conveying path; and
a bending device which bends a portion of the conveying path located downstream of the counting device at a predetermined angle, and is located to lie between the counting device and the cutting device.

2. A sheet cutting apparatus according to claim 1, wherein the counting device has a sensor which counts the sheets one by one by transmitting light through each of the sheets or receiving light reflected from each of the sheets.

3. A sheet cutting apparatus according to claim 1, wherein the conveying device has a pair of feed rollers which feed the sheets to the cutting device, and a guide member which guides the sheets into the pair of the feed rollers, and an end portion of the guide member is projected from the pair of the feed rollers by a predetermined amount in a feeding direction of the sheets.

4. A sheet cutting apparatus according to claim 3, wherein the bending device has a bending roller, and the bending roller is provided to be located on a straight line connecting an almost central position of the guide member on the conveying path and an almost central position of the counting device on the conveying path.

5. A sheet cutting apparatus according to claim 1, wherein the cutting device has a cutting blade, the cutting blade has a first and a second cutting blades, and each of the first and second cutting blades has a structure in which a plurality of disc-shaped blades each having projecting edges on its periphery are arranged at regular intervals on a central shaft thereof.

6. A sheet cutting apparatus comprising:
a conveying device which conveys sheets along a conveying path;
a counting device which counts the sheets conveyed by the conveying device;
a cutting device which receives the sheets counted by the counting device and carried out of the conveying path into a casing, cuts the sheets by a cutting section, and discharges cutting pieces being the cut sheets from a discharge port; and
an air nozzle which blows air onto the cutting section and sends the cutting pieces to the discharge port.

7. A sheet cutting device according to claim 6, wherein the counting device has a sensor which counts the sheets one by one by transmitting light through each of the sheets or receiving light reflected from each of the sheets.

8. A sheet cutting apparatus according to claim 6, wherein the conveying device has a pair of feed rollers which feed the sheets to the cutting device, and a guide member which guides the sheets into the pair of the feed rollers, and an end portion of the guide member is projected from the pair of the feed rollers by a predetermined amount in a feeding direction of the sheets.

9. A sheet cutting apparatus comprising:
a conveying device which conveys sheets along a conveying path;
a counting device which counts the sheets conveyed by the conveying device;
a cutting device which receives the sheets counted by the counting device and carried out of the conveying path into a casing, cuts the sheets by a cutting section, and discharges cutting pieces being the cut sheets from a discharge port;
an air nozzle which blows air onto the cutting section and sends the cutting pieces to the discharge port; and
an intake port section which is provided on a side of the casing opposite to the discharge port, and takes the air into the casing with blow of air by the air nozzle.

10. A sheet cutting apparatus according to claim 9, wherein the counting device has a sensor which counts the sheets one by one by transmitting light through each of the sheets or receiving light reflected from each of the sheets.

11. A sheet cutting apparatus according to claim 9, wherein the conveying device has a pair of feed rollers which feed the sheets to the cutting device, and a guide member which guides the sheets into the pair of the feed rollers, and an end portion of the guide member is projected from the pair of the feed rollers by a predetermined amount in a feeding direction of the sheets.
